(19) United States
(12) Patent Application Publication
(10) Pub. No.: US 2021/0004526 A1
(43) Pub. Date: Jan. 7, 2021

(54) Document Viewer Aligning PDF and XML

(71) Applicant: Rocky KAHN, Alameda, CA (US)

(72) Inventors: Rocky Kahn, Alameda, CA (US); Heng Liu, Alameda, CA (US)

(73) Assignee: Tactility, Inc., Alameda, CA (US)

(21) Appl. No.: 15/733,565

(22) PCT Filed: Feb. 28, 2019
(86) PCT No.: PCT/US19/20170

§ 371 Date: Aug. 28, 2020

Related U.S. Application Data
(60) Provisional application No. 62/636,771, filed on Feb. 28, 2018.

(51) Int. Cl. G06F 40/154; G06F 40/143; G06F 40/117

(52) U.S. Cl. CPC G06F 40/154; G06F 40/117; G06F 40/143

(57) ABSTRACT

Some processes can benefit from restructuring or editing submitted documents. For example, patent examiners could benefit from viewing claims in a collapsible hierarchy, reflowing content tablet displays, or editing ex officio corrections. Accordingly, it can be beneficial to interact with the document in a Markup Language format such as XML which facilitates restructuring and editing. However, applicants largely refuse to adopt XML filing solutions proposed by the USPTO and the EPO. The present invention allows applicants to continue filing PDF for initial and subsequent submissions while facilitating a transition to a XML working process. After automatically capturing content, it provides an ergonomic interface, allowing users throughout the process to manually touch-up OCR artifacts, mathematical equations, and chemical structures. When both PDF and XML are available, examiners may seamlessly switch between formats and versions while retaining context and a given Annotation appears in all formats and versions.

### CROSS-REFERENCE TO RELATED APPLICATIONS

This application claims the benefit of U.S. Provisional Application No. 62/636,771, filed Feb. 28, 2018, incorporated by reference herein.

### FIELD OF THE INVENTION

The present invention relates to techniques facilitating the “data capture” of one or more versions of a document in a format with less syntactic structure (e.g. PDF) to a format with greater syntactic structure (e.g. XML) and facilitating review and Annotation across these formats and versions.

### BACKGROUND OF THE INVENTION

### PDF

Many PDF documents were originally prepared in a Markup Language in which an author specifies syntactic elements such as paragraphs, headings, captions, etc. The author then converts the document by either exporting or printing to PDF.

PDF is a page content model based on PostScript aimed at final form output. PDF is an “envelope” format which can contain details in a range of different encodings. For example, a given page in a PDF document can be image-only (SVG, JPG, TIFF, etc.), image with text-backing, or full-text. When a page is provided with text-backing or as full-text, the PDF typically includes Content Data such as Text Elements. Depending on the PDF generation method, the Text Elements specify text of varying granularity: characters, words, and lines. For example, each character may be a separate Text Element, allowing the PDF to specify inter-character spacing (kerning). Alternatively, each word may be a separate Text Element, using default kerning but controlling inter-word spacing (tracking). Alternatively, each line may be a separate Text Element, using default kerning and tracking.

In PDF version 1.3, and Acrobat 4, Adobe added support to the PDF standard for carrying a document Structure Tree. Unlike XML, where tags that specify a Structure Tree are interleaved with Content Data (inline approach), PDF models the Structure Tree separately (standoff approach) and its elements point to the required Content Data. Within the PDF format, the Structure Tree is built up from dictionaries that represent the different elements (Element Dictionary), similar to the way an XML tree is presented to a programmer when loaded via the Document Object Model (DOM). To enable nodes of the PDF Structure Tree to point to the content they enclose, markers are placed within the Content Data stream to demarcate the blocks of content. These markers are each given a unique number called a Marked Content Identifier (MCID) that allows them to be referenced from the Element Dictionary.

With the advent of PDF 1.4, the Structure Tree implementation was refined further and given the name Tagged PDF (an Element Dictionary may be referred to as a PDF Tag) to differentiate it from PDF 1.3's Structured PDF. Tagged PDF was a refinement of the rules for structure, which included a mandatory end marker to terminate each word (a space character or other whitespace must be provided, in addition to the horizontal movement needed to justify the text). Furthermore, the rules of Tagged PDF allow PDF files to be read by voice synthesiser software, reflowed for display on devices such as PDAs and mobile phones, and facilitating extraction for use in other documents. For example, PDF Tags can group Text Elements into paragraphs, distinguish headings, and distinguish captions.

It is possible, in PDF software such as Adobe Acrobat, to edit the Structure Tree of a PDF interactively. New elements can be added, old elements deleted and the whole structure rearranged as necessary. However, contrary to users' expectations, manipulation of the structural ordering generally has no effect on page appearance. For example, if one changes the order of two paragraphs in the Structure Tree, this will not be reflected within the document as seen on screen (though it will lead to a different reading order when read by screen-reading software). This effect arises because the Structure Tree is external to the Content Data. Unlike an XML document, where the Structure Tree defines the route through the document, and the content is interleaved within it, the Structure Tree in a PDF is an external construct that has often been added after the Content Data has been recorded.

### Content Management System

Software adapted to work with documents in the context of a process is sometimes called a Content Management System (CMS). For example, the European Patent Office (EPO) tendered for a CMS system in order examiners can view and Annotate documents in dossiers containing applications, forms, actions, and prior art while navigating the patent grant process. Most modern CMS are implemented to run natively in a web browser (Web CMS).

### Markup Language

A process beginning with a PDF document sometimes benefits from an ability to modify a rendered Structure Tree in a way that changes content appearance. For example, a patent examiner may benefit from viewing patent claims in a tree hierarchy, expanding and collapsing branchies while reviewing multiple dependencies at each dependency location. Modifying a rendered Structure Tree also facilitates ergonomics (e.g. reflowing text content to view on a mobile device). Alternatively, an examiner may want to edit an obviously mistaken reference numeral via an ex officio office action. In these and other cases, it can be beneficial to interact with the document in a Markup Language format which facilitates changing presentation and editing. In order to provide these and other Markup Language capabilities while also providing access to the original document format, a Web CMS may provide access to documents in both as-filed PDF format and in converted Markup Language format.

### Patent Office Process

Some patent offices receive applications predominately in Portable Document Format (PDF) while working internally in and publishing a fulltext XML schema based on a World Intellectual Property Organization (WIPO) standard, ST.36. For example, the US Patent and Trademark Office (USPTO) receives initial and subsequent application filings in PDF format (aside from those received on paper or as DOCX) and publishes in Red Book format (a ST.36 derivative). Similarly, the European Patent Office (EPO) receives initial and subsequent application filings in PDF (aside from those received on paper and about 1% of initial filings received as XML) and publishes in ST.36 format.

Offices typically normalize filings to TIFF page images and engage a vendor to perform data capture, including:
Optical character recognition (OCR);
OCR touch-up (e.g. manually correct misrecognized characters, styles);
Encoding complex work units such as
   Mathematical equations (for which there are only research projects to automatically capture from PDF) and
   Chemical structures (for which there are automatic capture systems operating at ˜94% accuracy for single structure diagrams),
   Tables (which are encoded in CALS), and
   Biological sequences (which are encoded in a special table structure); and
Syntactic tagging (e.g. identify headings, which lines are part of a given paragraph, captions, etc.).

Examiners at the USPTO and the EPO typically have access to the application as both PDF and XML. The PDF format is the legal version (the TIFF page images are regarded as a trustworthy representation of the PDF but the captured XML cannot be completely relied on) while the XML is more ergonomic and accessible.

The requirement to convert PDF to XML has led the USPTO and the EPO to a dual-data pipeline, separately processing TIFF page images and XML content, with no ability to automatically propagate examiner's work from one format to the other or from one version to another. For example, if an examiner applies an Annotation to a PDF to note an inconsistent part reference (e.g. as a reminder to herself to object to the error in an office action), the Annotation will be unavailable in the XML format. This can result in errors (e.g. if the examiner reviews the Annotations only on the XML format when preparing an office action and thereby omits the inconsistent part reference Annotation in the PDF) or duplicate effort (e.g. if the examiner inadvertently creates duplicate Annotations objecting to the inconsistent part reference in both PDF and XML).

The independent PDF/XML formats also hinder development of examination software to automate repetitive tasks. For example, offices might be more inclined to prioritize development of software to check for inconsistent part references and antecedent basis errors if these tools could be provided consistently across all formats in which examiners might view an application.

A straightforward approach to addressing the above issues is to require applicants to file applications in a more structured format such as Red Book or ST.36 at the USPTO or the EPO, respectively. The present inventors demonstrated such an approach at the USPTO in 2010 in response to a procurement entitled, “Patent End-to-End (PE2E)” and supplied such a system at the EPO from 2011 in response to a procurement entitled, “A Case Management System for the EPO's patent grant process”.

However, current laws/rules allow applicants to file in PDF (and it is difficult for patent offices to change those laws/rules) while many patent attorneys are “later adopters” so are unwilling to adopt new technology until necessary (“later adopters” is a group in the technology adoption life cycle as described in Rodgers' bell curve from “Diffusion of technology”). As a result, the USPTO and the EPO continue to receive filings predominately in PDF format. These offices contract with patent data capture vendors to convert applications to XML and thse offices maintain examiner software tools supporting both formats as independent documents. This hinders automation and results in increased cost, errors and delays.

### SUMMARY OF THE INVENTION

In order patent offices may improve their filing process in an incremental fashion (rather than a “big bang” change where all applicants are required to modify their process), the present invention allows earlier adopter applicants to file XML while later adopter applicants continue filing PDF. The terms, “earlier adopter” and “later adopter” derive from the “technology adoption life cycle” described by Rodgers' bell curve in “Diffusion of Innovations”. An embodiment of the present invention encourages applicants to touch-up the XML generated from an automatic conversion process, while avoiding situations in which an applicant feels liable for ensuring the conversion is correct. Another emodiment of the present invention is directed to data capture vendors, providing an ergonomic user interface for touch-up and facilitating integration of legacy capture and correction services. In another embodiment, when both PDF and XML are available, examiners may seamlessly switch between formats while retaining context (i.e. the PDF and XML formats are in Alignment) and annotations on either format appear in the other. These capabilities enable enhanced automation, providing improved productivity, quality, and timeliness.

Applicants upload PDF and see a fixed-layout view in one panel and an editable, reflow-layout view of the converted XML in an adjacent panel. When the applicant has completed validation and submitted the application, the system generates a filing receipt the applicant can download consisting of the originally-submitted PDF with changes indicated using track change comments. Since the page content (aside from the track change comments) is unchanged from what the applicant originally filed, the filing receipt be regarded as a trustworthy representation.

The present invention has been implemented to support structured amendments according to a document replacement method described in WIPO's “PCT Paragraph Replacement” proposal dated 5 Nov. 2010 and incorporated by reference into the present application. Before preparing subsequent amendment filings, the applicant may incorporate track change comments from the PDF filing receipt into the original source (e.g. a Microsoft Word document). Alternatively, applicants can accept changes in a DOC(X) filing receipt. Applicant makes changes in Microsoft Word, exports to Tagged PDF, and uploads the amended version; an embodiment of the present invention automatically amends the XML format and ensures all formats and versions are in Alignment and Annotations in a given version propagate to subsequent, amended versions. This allows examiners to ask, for instance, in which version a given claim passage was introduced.

The aforementioned embodiment of the present invention can be extended to support all methods specified in USPTO MPEP 714, permitting amending . . .
Specification (inc. abstract) by
   paragraph replacement
   section replacement
   document replacement (substitute specification)
Claims by marked up document replacement
Drawings by replacement sheets

### BRIEF DESCRIPTION OF THE DRAWINGS

FIG. 1 illustrates a computer system that may be used in an embodiment of the present invention.

FIG. 2 illustrates components of an embodiment of the present invention.

FIG. 3 illustrates Edit Steps applied to the XML and a subsequent filing (amendment) of the PDF.

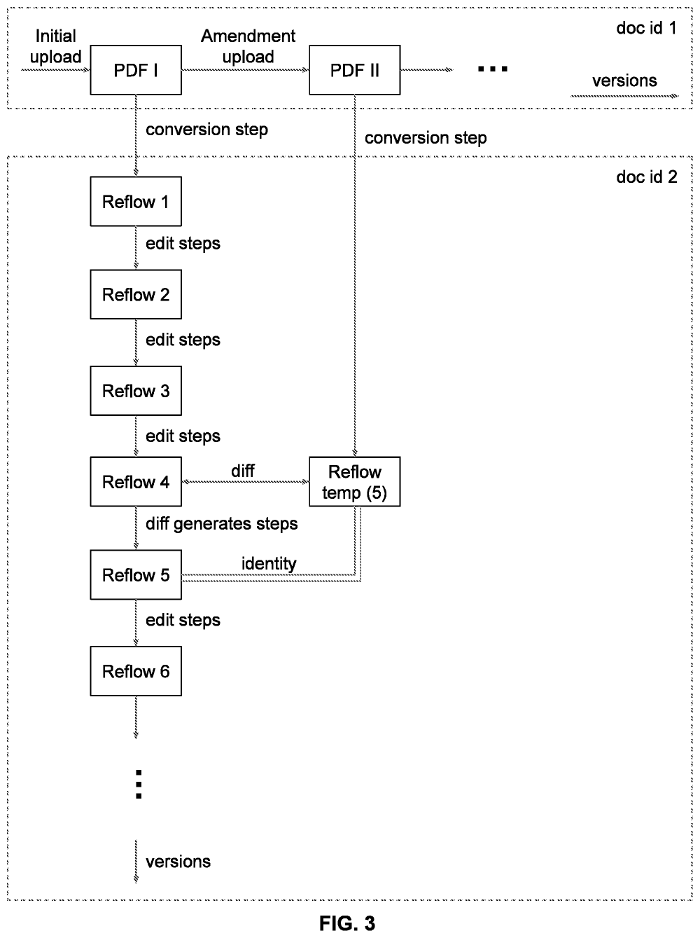

FIG. 4 illustrates Alignment with a Selection in XML triggering an Emphasized Corresponding Range in PDF.

FIG. 5 illustrates Alignment with a Selection in PDF triggering an Emphasized Corresponding Range in XML.

FIG. 6 illustrates Selective Interlining.

FIG. 7 illustrates PDF and XML in Alignment with the XML condensed to a series of snippets, each containing a validation warning.

FIG. 8 illustrates edits in XML reflected as a track change marks in PDF.

FIG. 9 illustrates Track Change Panel at bottom of PDF indicating Replacement Text for an XML Replacement Mark.

FIG. 10 illustrates an OCR touch-up embodiment highlighting low-confidence OCR captures and prompting user to specify correction.

FIG. 11 illustrates Alignment of an amended application.

### DETAILED DESCRIPTION

### Alignment

### Inline

The present invention was implemented to support the patent grant process so converts Tagged PDF to ST.36 or Red Book XML. The Tagged PDF could have instead been converted to other Markup Languages, such as HTML (TeamPatent.com uses XHTML, an XML-compliant subset of HTML). During conversion, PDF Tags distinguish syntactic elements such as paragraphs, headings, captions, lists, images, etc. For the patent grant process, the conversion process can use heuristics (some of which are demonstrated at TeamPatent.com) to further distinguish heading levels, sections (e.g. Abstract, Description, Claims, Drawings), parts (including reference numerals), claim terms, prior art references, figure references, claim references, image/equation captions, etc. Heuristics are intrinsically fallible so some conversion errors are inevitable.

In order to facilitate validating and correcting conversion errors, it can be valuable to “align” the PDF and Markup Language so users can inspect the PDF to understand intent while editing the Markup Language. Alignment hereafter means providing correspondence between a PDF and a Markup Language generated from the PDF so a range in one may be matched with a corresponding range in the other. Alignment further means the correspondence provides a resolution of individual characters (or at least individual words) and individual objects (e.g. images).

Alignment for the present invention has been implemented by copying MCIDs from PDF Tags to the XML. The present inventors initially wrapped each XML word with an XML Tag specifying the corresponding MCID, which produces a large number of XML Tags (one for each word). However, in browser-deployed software, XML documents are usually rendered as HTML and contemporary web browsers become sluggish when maintaining a Document Object Model (DOM) containing HTML with this many tags.

To improve performance, instead of applying an XML Tag MCID to each XML word, the system only applies an XML Tag MCID to elements appearing as Block Elements in HTML (e.g. paragraphs, lists, images, etc.). An XML Tag MCID on a paragraph then relates to a list of PDF Tag MCIDs, one for each word and for each space. The present invention was implemented to store a starting MCID and character offsets in the XML to each subsequent MCID. For example, an XML Tag wrapping a paragraph might contain the following attributes.
Initial MCID in the PDF paragraph=x
List of XML character offsets to subsequent MCIDs in the PDF paragraph={5,6,12,13, . . . }

Users may select a range in the PDF or in the Markup Language. In either case, this range is called a Selection.

In the above example, when a user specifies a Selection in the XML paragraph—e.g. a word with character offsets 6 through 11—the system finds a PDF Tag corresponding to the initial MCID in the PDF paragraph then emphasizes the second PDF Tag thereafter. A user may select a portion of a word and/or multiple words, in which case, the system emphasizes corresponding MCIDs (or parts thereof) in the PDF.

Alternatively, when a user specifies a Selection in the PDF, the system identifies the MCIDs associated with paragraphs containing the start and end of the Selection range and identifies character offsets to the start and end of the Selection range within those paragraphs. The encoding in the implemented system works as follows:
in PDF: <mcid=20>SOME</mcid><mcid=21></mcid><mcid=22>content</mcid>
in XML: <span start=20 offset=“4,1,7”>SOME content</span>

The basic operaration in the implemented system results in Mapping a range from PDF to XML or vice versa:
PDF→XML: point in PDF is “c|ontent” (where “|” character denotes the point), MCID is 22, offset is 1. In XML, search for all span's on the page with a start less than or equal to 22, the span with the biggest start is the span we need to use. In this case, we find <span start=20 . . . >. Then look at the offset to move the point to the correct position.
XML→PDF: the same point as in previous example: by using offset list on the XML span, we can tell the target in PDF is MCID=22 and offset=1.

### Standoff

Another more involved approach is to not generate XML Tag MCID elements but to instead maintain Alignment information in a standoff fashion, producing a Standoff Alignment Encoding Store (e.g. a JavaScript object separate from the XML store).

A Standoff Alignment Encoding Store could, for example, encode MCID correspondence information as a dictionary relating a PDF Tag MCIDs with a XML Tag and character offset therein.

There are ways other than with MCID to encode position information in PDF. For example, the PDF Tag MCIDs may be ignored and a Standoff Alignment Encoding Store can instead correspond PDF Tag Coordinates with XML Tag Coordinates (collectively, “Coordinates”) in an ordered list with, for example, the key a range in XML (encoded as a Coordinate) and the value a corresponding range in PDF (also encoded as a Coordinate), or vice versa (the PDF Coordinate being the key and the XML Coordinate being the value). Such Coordinates may, for example, be encoded according to U.S. application Ser. No. 13/077,348, “Capturing DOM Modifications Mediated by Decoupled Change Mechanism” by Liu et al., incorporated by reference herein. This latter method is similar to XPath but specifies elements numerically rather than by name, thereby facilitating binary search. Upon a Selection in XML or PDF, the system would perform a binary search to find the corresponding key-value pair containing the start and end-Selection Coordinates and thereby determine the Coordinates in the other format.

Alignment Encoding means the recording of correspondence between the PDF and the Markup Language representations. As described, the recording can be in the XML or in a Standoff Alignment Encoding Store (e.g. a JavaScript object). Also as described, the correspondence can be by ID (e.g. PDF Tag MCID or XML Tag ID) or by Coordinates (e.g. DOM hierarchy and character offset).

### Alignment UX

### Emphasis and Scrolling

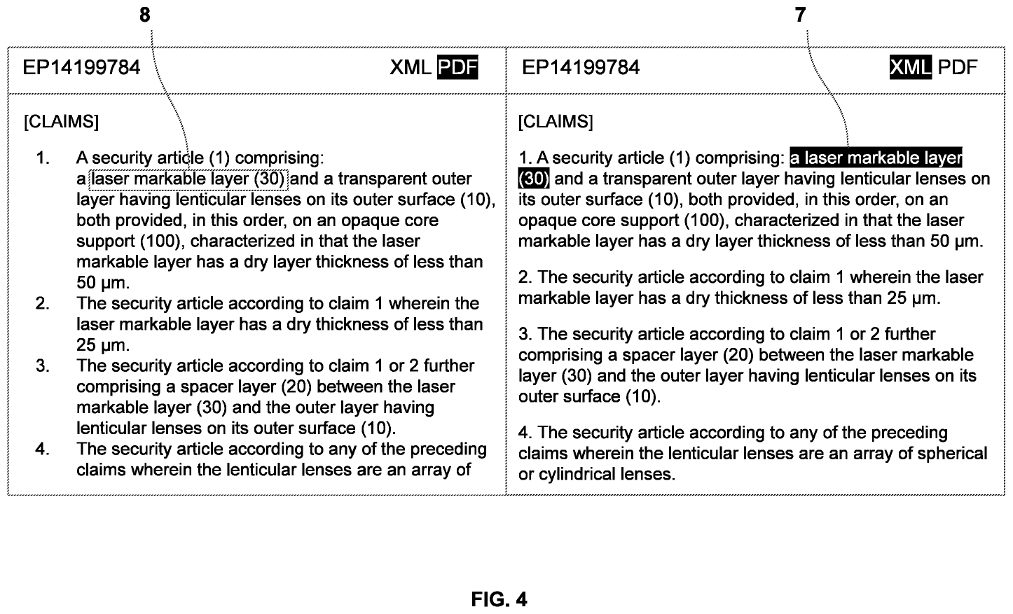

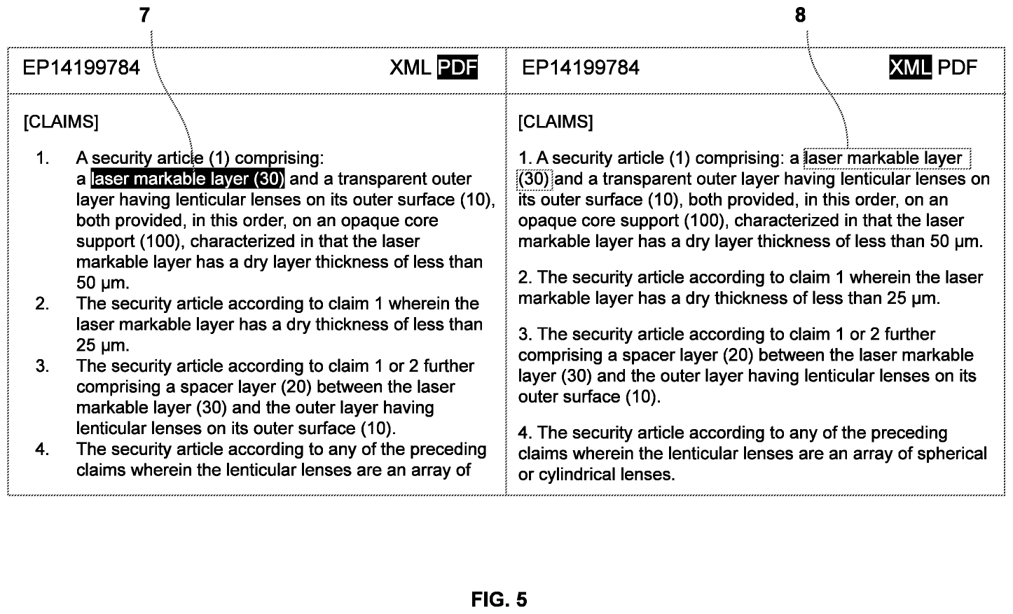

The present invention has been implemented to display the two formats side-by-side. Alignment providing correspondence between a PDF and a Markup Language can take the form of emphasizing a corresponding range upon user Selection 7. FIG. 4 illustrates when a user makes a Selection 7 in an XML document, the system can scroll into view an Emphasized Corresponding Range 8 in the PDF. FIG. 5 illustrates when a user makes a Selection 7 in an PDF document, the system can scroll into view an Emphasized Corresponding Range 8 in the XML.

### Eye Tracking

A system supporting eye tracking can use visual attention to specify Selection (e.g. Selection may be considered a word or object enclosing a focus of attention).

### Popup and Interline

If displaying both formats is not desired (e.g. due to limited screen size), the system can display one format and, upon Selection, display a snippet from the other format in a temporary view (e.g. a popup or slide-in panel).

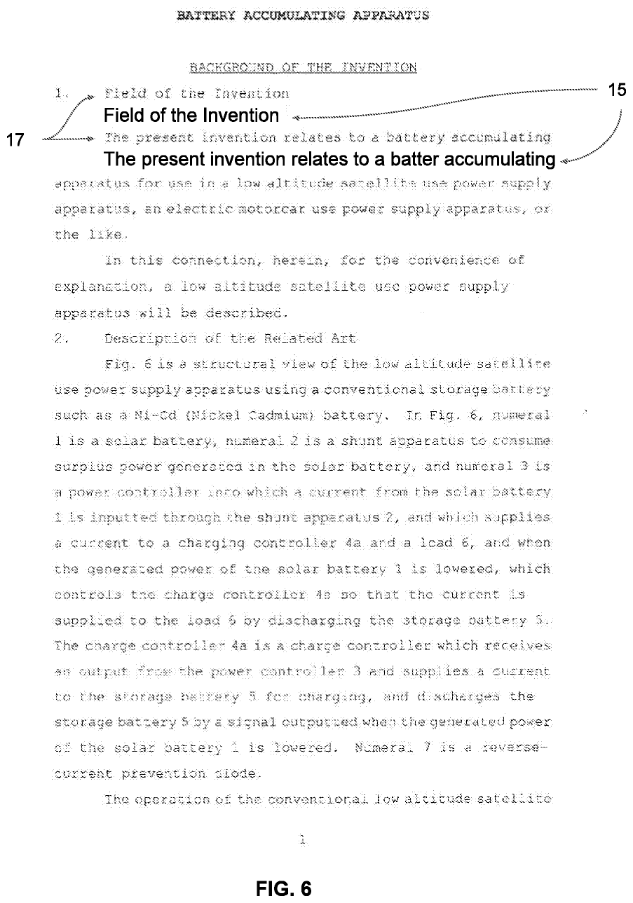

Alternatively, in order to show the two formats in a single view without obscuring content with a temporary additional view, the two formats may be displayed in an interline view where one format is “split” and separated to provide space for a content from the other format. This technique is henceforth called Interlining. For a document organized as rows of text and other objects, Interlining might display a row from one format, a row from the other format, and so forth. For a document organized as columns, Interlining might display a column from one format, a column from the other format, and so forth. Interlining could appear continuously (Continuous Interlining appears at all times) or dynamic (Dynamic Interlining occurrs upon trigger such as upon a Selection or an eye tracking focus). Interlining could appear globally (Global Interlining appears across all content rows or columns) or selectively (Selective Interlining appears on a limited number of content rows or columns centered around a range of interest). Selective Interlining uses display height more efficiently but results in dynamically shifting content, which can be distracting. Selective Interlining is illustrated in FIG. 6. Interlined XML Rows 15 appear between Interlined PDF Rows 17

Upon Selection when Interlining, it may be unnecessary for the system to emphasize a corresponding range in the other format since Interlining's close positioning of the other format may make the Alignment obvious.

### Editing

Some Web CMS providing Alignment may allow users or automatic agents to edit the Markup Language. Edit Steps may include inserting, deleting, and replacing content, including text and other objects (e.g. images). Edit Steps may also include adding, deleting, and modifying XML Tags, for example, in order to apply, remove, or change styles (e.g. changing a paragraph to a heading, bolding a word, etc.).

When XML is edited, the system may update the Alignment Encoding (e.g. modify XML Tags specifying the MCIDs) in order to maintain Alignment. For example, suppose plain text originally appears within a single XML Tag MCID.
When a user inserts/deletes text inside the XML Tag, the system may increase/decrease character offsets to subsequent MCIDs.
If an insertion includes an object (e.g. an image) or an additional paragraph (e.g. a user presses [Enter]), the system may split the containing XML Tag, creating additional XML Tags with appropriate MCIDs to point at preexisting content (e.g. splitting a paragraph creates new content—a new paragraph or CR/LF element—but the content of the split paragraphs exists in the original PDF so should retain an MCID pointer to that content).
Joining paragraphs (e.g. backspacing beyond beginning of a paragraph) would remove one or more XML Tags, possibly merging their contents and causing the system to adjust the start MCID and/or MCID character offset list within the resultant XML Tag.

Another, more involved approach is to leave the Alignment Encoding unchanged after conversion (whether encoding is inline with XML or in an external store) and maintain Alignment after editing by Mapping a Selection (e.g. in XML) through the Edit Steps. The particular Mapping approach depends on how Edit Steps are encoded. The present invention was implemented with ProseMirror as the Markup Language Viewer so Mapping could use the process described at https://prosemirror.net/docs/guide/#transform.mapping. Mapping would transform a Selection in an edited XML version to an earlier version where the Alignment Encoding is valid. Alignment could then be performed as if there had been no editing. This approach can work bidirectionally (i.e. from PDF to XML or from XML to PDF).

For example, conversion from PDF to XML results in version 1, in which an MCID span in the XML is valid. Upon editing the XML, the system leaves the XML Tag MCIDs unchanged so some MCIDs become invalid. When Alignment of a Selection in the XML is needed, Mapping transforms the Selection through the Edit Steps since version 1 and then looks up the MCIDs for the resulting Selection in version 1 to identify the corresponding PDF Selection. When Alignment of a PDF Selection is needed, the system identifies an Alignment to XML version 1 then performs Mapping of that XML Selection through all Edit Steps since version 1 to the current version. A Selection may consist of a non-collapsed range, in which case, the system separately performs Mapping on the start and end range from XML to PDF or vice versa.

### Editing UX

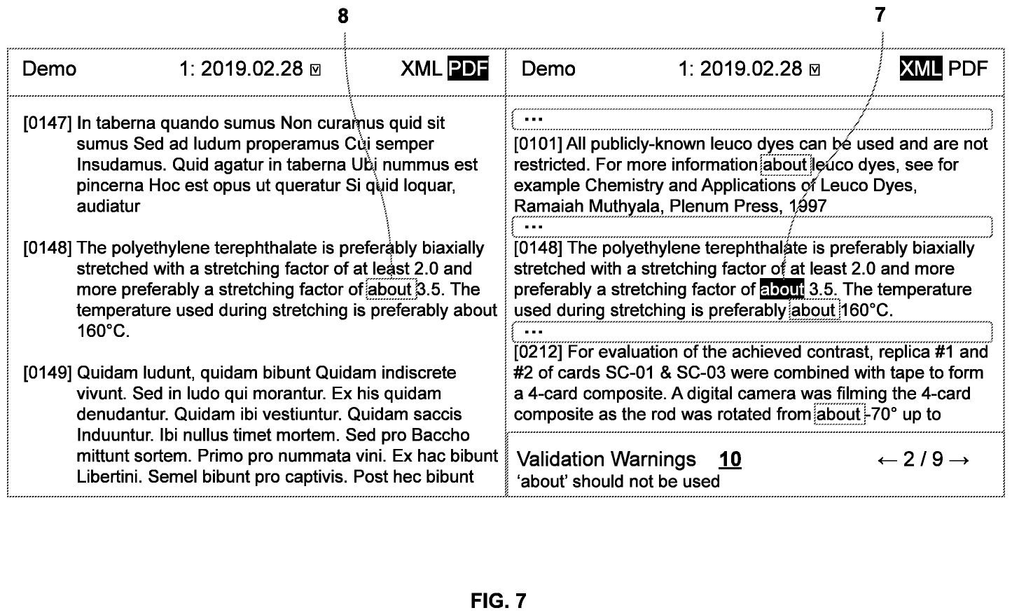

The EPO taught us that if the reflow view displays the entire converted XML application, some applicants feel liable to ensure the conversion is perfect. Rather than compare the PDF and reflow line-by-line, which would be onerous, these applicants are unwilling to be shown the converted XML. In order to promote applicant adoption, an embodiment of the present invention condenses the reflow view to a series of snippets, each containing a validation warning. FIG. 7 illustrates this condensed XML view. A Selection 7 in XML results in an Emphasized Corresponding Range 8 to be emphasized in the PDF. A Validation Warning 10 is shown at the bottom of the XML. Validation Warnings 10 could include conversion report issues such as those emitted by USPTO's DOCX importer or WIPO's ePCT application body converter, TeamPatent.com's fine-grain validation warnings, low-confidence OCR captures, complex work unit, imperial units in a European application, etc.

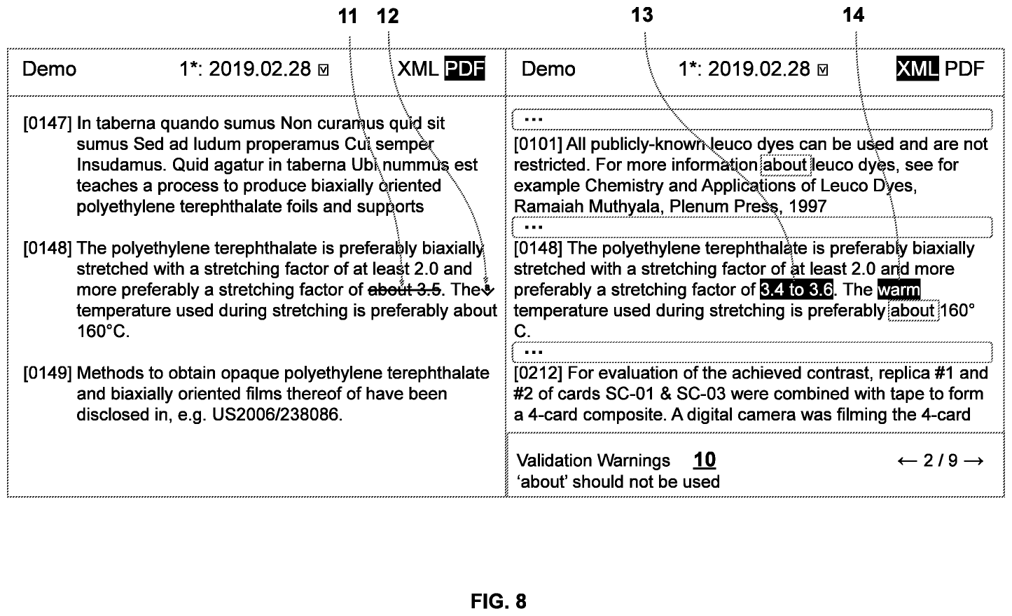

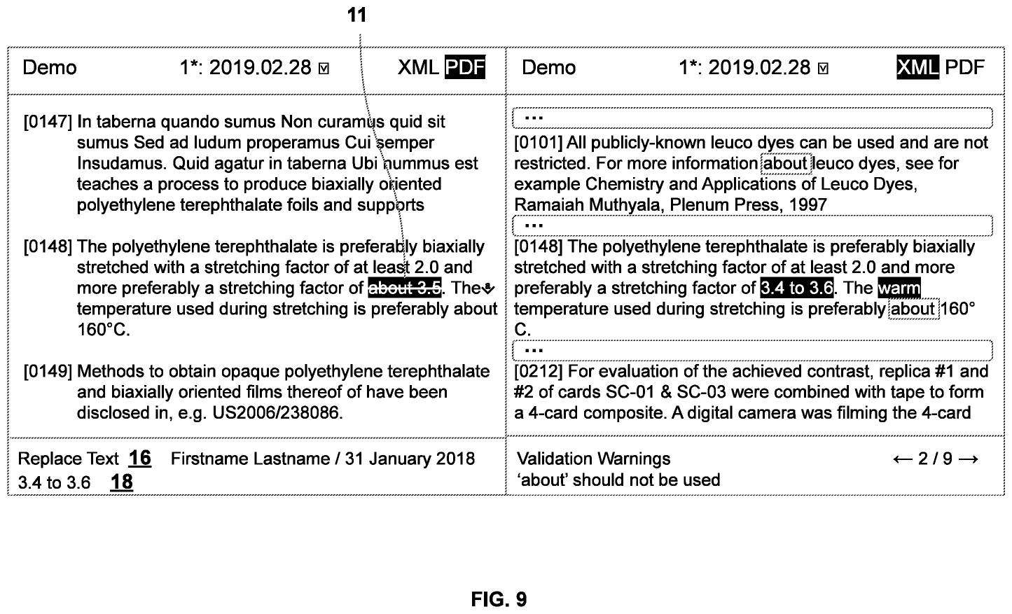

Content inserted in the XML may be displayed there with an emphasized style (e.g. Google Docs <Suggesting> mode uses author-keyed colored highlights; Microsoft Word uses author-keyed colored, underlined text). Insertions do not appear in the PDF but an insertion mark (e.g. caret) can be displayed as a track change annotation on the PDF. Content deleted from the XML may be displayed there with an emphasized style (e.g. Google Docs <Suggesting> mode and Microsoft Word Track Changes use strikeout style. Deletions remains presented in the PDF but a deletion mark (e.g. strikethrough) can be displayed as a track change annotation on the PDF. FIG. 8 illustrates an XML Replacement Mark 13 (“about 3.5” is replaced by “3.4 to 3.6”) and a XML Insertion Change 14 (“warm” is inserted before “temperature”). These appear as a Strikethrough Deletion/Replacement Mark 11 and a Caret Insertion Mark 12. FIG. 9 illustrates when user clicks on Strikethrough Deletion/Replacement Mark 11, a Track Change Panel 16 opens at bottom to display Replacement Text 18.

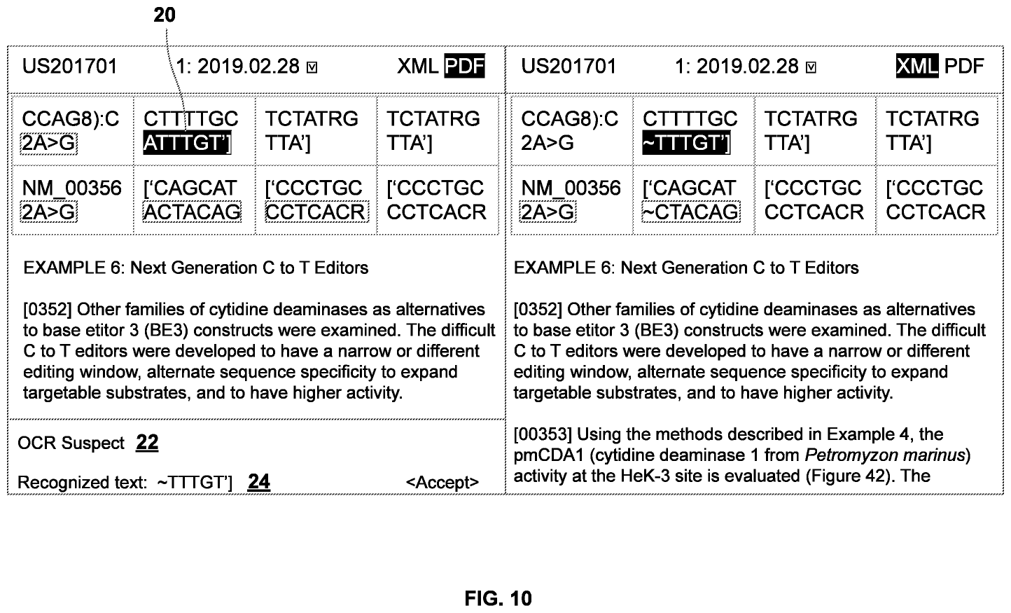

FIG. 10 illustrates an OCR touch-up embodiment. The system displays Low-Confidence Capture Mark 20. Upon clicking, OCR Suspect Panel 22 opens at bottom and displays Captured Text 24. User can replace Captured Text 24 with correct content (creating an XML Replacement Mark and a Strikethrough Deletion/Replacement Mark 11.

### Filing Untagged PDF

The USPTO and the EPO recommend applicants produce PDF applications from Microsoft Word by <Print to PDF>. This method generates Untagged PDF, so most current application PDFs submitted to the USPTO and the EPO contain Content Data but do not contain PDF Tags. Applications such a Adobe Acrobat can automatically add PDF Tags to an Untagged PDF, but the method is driven by heuristics (e.g. the position and style of Text Elements) which is inherently fallible, resulting in a significant error rate.

Patent offices may instead recommend applicants generate PDF from Microsoft Word by <Save as PDF>, which generates a Tagged PDF. However, for the indefinite future, offices must be prepared for at least some applications to arrive as Untagged PDF.

The present invention could be extended to automatically tag an Untagged PDF (e.g. using Adobe Acrobat as an external service) and allow users to manually touch-up the PDF Tags, similar to the functionality available in Adobe Acrobat. Assuming manual PDF Tag touch-up can be done at any time in the process (e.g. interspersed with other Edit Steps), the system may generate an Alignment Encoding after an automatic tagging process and subsequent manual PDF Tag touch-up shall be treated like other Edit Steps, thereby maintaining Alignment.

### Filing Image PDF

The USPTO and the EPO allow applicants to submit applications as Image PDF. These are PDFs where the Content Data typically consists of an image for each page with neither Text Elements nor Tags. Since the USPTO and the EPO normalize all applications to TIFF page images, receiving Image PDF is similar to what data capture vendors typically face, even when applicants file Tagged PDF or DOC(X). If patent offices adopted the present invention, they would no longer normalize all applications to TIFF page images and may discourage applicants from filing Image PDF. However, for the indefinite future, offices must be prepared for at least some applications to arrive as Image PDF.

The present invention has been extended to be used in conjunction with a OCR engine to provide touch-up. The present invention imports OCR recognition data, emphasizes suspicious items (words with low recognition confidence), and requests users approve or correct low confidence items. This integrates capture into an electronic dossier system, allowing “progressive” touch-up—the system can provide machine capture (e.g. automatic OCR and tagging) before and during examination and later facilitate manual touch-up before publication, all while maintaining Alignment of the examiners' work.

### Filing DOC(X)

The USPTO currently promotes DOCX import via an eMod pilot which has now entered production as “Text Intake in EFS-Web”. The team supporting this initiative stated that DOCX was converted to PDF and thence to TIFF. This provides few advantages over PDF filing.

The present invention can be adapted to convert documents filed in DOC(X) format to Tagged PDF. As in the previous embodiment, Alignment would occur between the PDF and XML views. Modifications would be indicated as track changes on the PDF.

Upon submission, the system may also generate a filing receipt the applicant can download consisting of the originally-submitted DOC(X) with changes indicated using Microsoft Word's track change mechanism. Since the original content (with track changes showing only the original content) is unchanged from what the applicant filed, this may be regarded as a trustworthy representation. With this method, the filing receipt is the current version so applicants may immediately use it to prepare subsequent amendments.

### System Topology

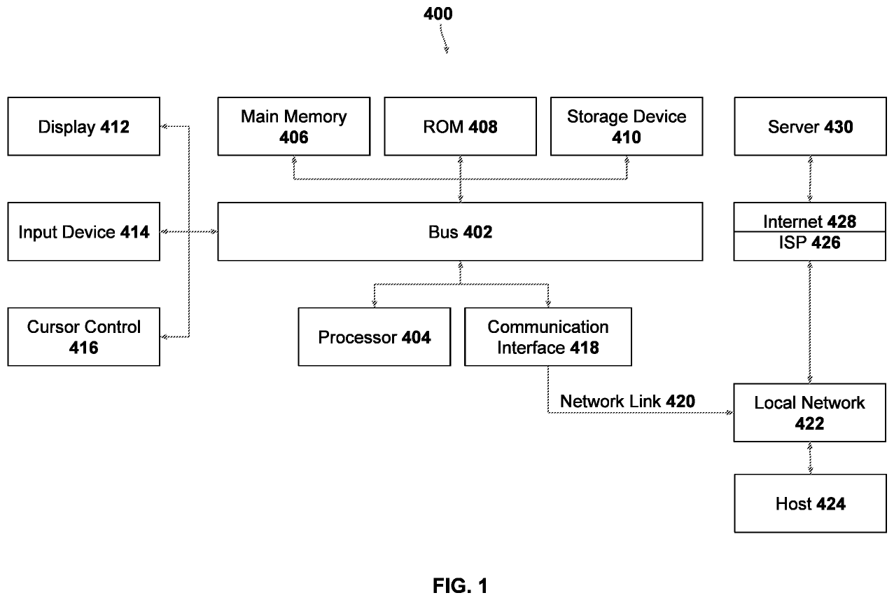

FIG. 1 illustrates a computer system 400 which may suitably embody one implementation of the invention. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to the bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions. The main memory 406 could be distributed or local and the processor 404 could be distributed or singular. It should also be noted that some or all of computer system 400 can be incorporated into a personal computer, laptop computer, handheld computing device.

Computer system 400 may be coupled via bus 402 to a display 412, such as a cathode ray tube (CRT), liquid crystal display (LCD), or the like, for displaying information to a user. An input device 414, including alphanumeric and other keys, is coupled to bus 402 for communicating information and command selections to processor 404. Another type of input device 414 is a cursor control 416, such as a mouse, a trackball, or cursor direction keys for communicating direction information and command selections to processor 404 and for controlling cursor movement on display 412.

The invention is related to the use of computer system 400 modified as described herein for implementing the techniques described herein. According to one embodiment of the invention, those techniques are performed by computer system 400 in response to processor 404 executing one or more sequences of instructions contained in main memory 406. Such instructions may be read into main memory 406 from another machine readable medium, such as the storage device 410. Execution of the sequences of instructions contained in main memory 406 causes processor 404 to perform the process steps described herein. In alternative embodiments, hard wired circuitry may be used in place of or in combination with software instructions to implement the invention. Thus, embodiments of the invention are not limited to any specific combination of hardware circuitry and software.

The term “machine readable medium” as used herein refers to any medium that participates in providing data that causes a machine to operation in a specific fashion. In an embodiment implemented using computer system 400, various machine readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402.

Common forms of machine readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the Internet 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a Server 430 might transmit a requested code for an application program through Internet 428, ISP 426, local network 422 and communication interface 418.

The received code may be executed by processor 404 as it is received, or stored in storage device 410, or other nonvolatile storage for later execution. In this manner, computer system 400 may obtain application program code in the form of a carrier wave.

### Components

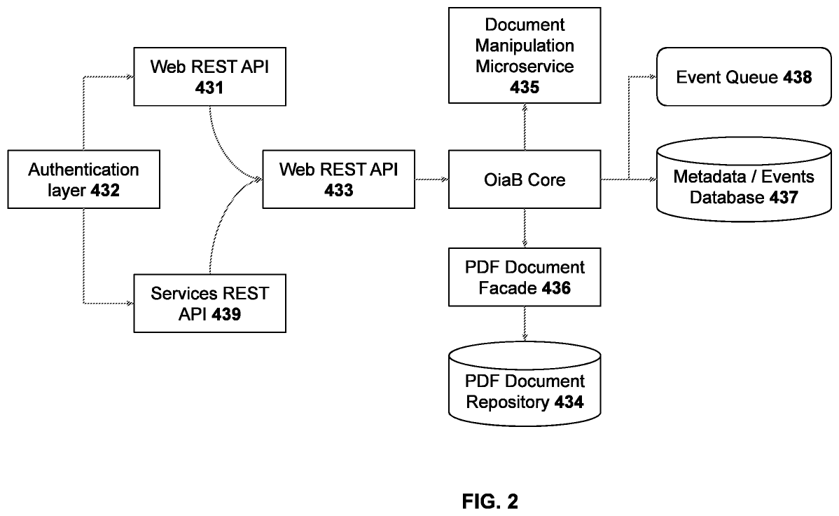

FIG. 2 illustrates a high-level overview of key components in various embodiments of the present invention, sometimes called (Patent) Office in a Box (OiaB):
Authentication Layer 432: multiple authentication strategies can be provided, including simple login/password, oauth and Kerberos authentications. The platform can be configured to use built-in authentication or external, enterprise-wide provider (e.g. through application server).
Web REST API 431: set of REST endpoints consumed by OiaB web client.
Central Authorization Service 433: separated authorization layer. This layer abstracts the authorization rules. Thanks to this layer, OiaB can be easily integrated with enterprise-level permission systems (e.g. LDAP).
PDF Document Repository 434 and PDF Document Facade 436: OiaB serves PDF documents to users. OiaB accesses the PDF document repository 434 through PDF Document Facade 436 so the system can be configured to either use a built-in repository or a repository that already exists within the enterprise.
Document Manipulation Microservice 435: handles real-time collaboration on documents.
Metadata/Events Database 437: stores all events (such as uploading or modifying a document), including the Step Table.
Event Queue 438: exposes all events that happen in the system to external consumers.
Service REST API 439: set of REST endpoints used by external systems to load data to/retrieve data from OiaB.

Event Queue 438 and Service REST API 439 allow the system to provide synchronization of data between OiaB and existing enterprise systems. Such an external integration/synchronization component would listen for events emitted by OiaB (to the Event Queue 438) and push appropriate changes to other systems. Similarly, updates coming from external systems would be propagated to OiaB through the Service REST API 439. These components allow a gradual staged roll-out of the new system.

### Data Model

An embodiment of the present invention was implemented using ProseMirror (http://prosemirror.net), an open source web rich-text editor toolkit, as a Markup Language Viewer. The following details that implementation.

The system uses “index” in ProseMirror to designate an Anchor or a Selection in a document per http://prosemirror.net/docs/guide/#doc.indexing. The index can be Mapped (resequenced) through different versions per http://prosemirror.net/docs/guide/#transform.mapping.

Both “regular” Markup Language documents (e.g. a patent specification) and Annotations are maintained as XML documents in the system. Annotations are documents which have an Anchor in another document (in a “regular” document or in another Annotation).

Anchors are cached in a database as a document. The content of such a document may look like:

<document>

<body>
<p>This is an Annotation comment referencing <a
href=″ref:uuid_for_a_ref″>another
document</a>.</p>
</body>
<meta>
<title>title of this document</title>
<parent doc=”doc_uuid” version=”doc_version” />
<refs>
<ref id=″uuid_for_a_ref″ doc=″target_doc_uuid″ rev=″version_num″
begin=″start_index_num″ end=″end_index_num″/>
</refs>
</meta>
</document>

The <ref> is a definition of an Anchor. Multiple Anchors may be specified in <refs>, resulting in the Annotation being Anchored at multiple locations. An Anchor requires the following data:

1. a document id

2. a version of the document the range was created on

3. a Selection (i.e. a range: start index and end index)

The <a> tag is an optional location where it's used in the content of the document. This allows an annotation to have an Anchor and then discuss the meaning of that Anchor in a comment. This is helpful, especially when there are multiple Anchors present. For example, patent office actions may be composed of an Annotation for each objection or rejection basis. Suppose a “lack of novelty” rejection Annotation includes the following content, “Data area 74 in paragraph 0033 includes remote backup data center 24, as shown in paragraph 0017 and FIG. 2”. To support such a rejection statement, three Anchors may be specified in <ref>: one to “Data area 74” (in [0033]) and two to “remote backup data center 24” (in [0017] and FIG. 2). These refs are used in the content (as <a> tags) to make the citations clickable (e.g. a user can navigate from “Data area 74 in paragraph 0033” to the appropriate reference).

In some cases, there may be only one or more <ref> elements and no corresponding <a> tags. In other cases, both may be present. For some <ref> elements, there may be multiple <a> tags present in the document main content (i.e. the content can cite a given Anchor multiple times). The doc attribute on <ref> element points at the linked document.

refs are in the same document as the content for a document, so any insertion/deletion/modification of refs will be in the same undo/redo queue as the other changes on the document.

When the system persists content on the backend, there is a single golden source, the Step Table. All other tables can be recreated by inspecting this Step Table. Every other table is only used as a cache to speed up queries of the database. The Step Table is append only: we never modify or remove anything (only exception is to support purge, where steps can be removed). An Edit Step in the Step Table has the following schema:
1. id: each Edit Step has a unique identifier (e.g. an incremental number)
2. doc id, document uuid
3. num: step number for a particular document (starting from 0 and incrementing every time a new step is made for a document)
   1. The present implementation currently creates a linear rather than branched history so acceptable for front-end to assign num. However, when branching supported, could adopt approach where frontend proposes a num (it's actually a string from current timestamp) and backend assigns the proper num and returns it to frontend. This method is described in U.S. application Ser. No. 13/077,348, “Capturing DOM Modifications Mediated by Decoupled Change Mechanism” by Liu et al., incorporated by reference herein.
   2. When Edit Steps are purged, this leaves a gap in num. System could renumber all remaining num if a gap is undesirable.
4. timestamp when this step is made. Have Server 430 rather than client specify date-time in order to prevent tampering. To support offline, system may also have front-end client supply date-time.
5. author: a uuid pointing at a user in user table
6. json (jsonb field): this field contains the Edit Step info sent from frontend. The content of this field is dependent on the next field
7. change_type: for ProseMirror, this field distinguishes between following (for other json documents—e.g. sketch, PDF—types are different)
   1. a step which create a document and
   2. incremental change steps, and to further distinguish between
      1. prosemirror type steps and others. for example, 0 means deletion of a document (mark as deletion), 1 is creation of a document, 2 is incremental update (Edit Step)

The system may introduce additional columns to speed up Mapping (resequencing) of Anchors when an Anchored document is edited. Optimizing Mapping (resequencing) is described in U.S. application Ser. No. 13/077,348, “Capturing DOM Modifications Mediated by Decoupled Change Mechanism” by Liu et al., incorporated by reference herein.

When Server 430 receives a step to create a document, it will make sure the uuid (uuid should be generated by backend) for this document does not already exist in a Documents Table, which could have the following fields:
1. id: each document shall have a unique identifier
2. doc_id: uuid of a document (this may not be unique, as different versions of a document may have duplicates in this document table, because it's helpful to show all versions in the TOC table)
3. version: this version field specifies a particular version (in Step Table).
4. parent: uuid of parent document or null
   1. this is null for dossier metadata document.
   2. For all other documents, parent id points to dossier metadata document (the body for the dossier document is the meta data, such as dossier number, title, assignee, classification etc.) . . .
      1. except documents generated from other documents, such as reflow generated from PDF or PDF generated from DOC(X) (so if a document has alternative format available, we can look for child or parent documents of a different type, if available, they can be shown as alternative format when displaying the parent or child document)
5. parent_version: version from which this document is created
6. type: 0 for ProseMirror, 16 for json documents, 32 for PDF (inferred from the change_type field of the creation step)
7. title
8. created by: a uuid pointing at a user in user table who created this doc
9. creation date: GMT date-time of creation
10. last modified by: a uuid pointing at a user in user table who last modified this doc
11. last modified date: GMT date-time of last modification
12. state: 0 means deleted, 1 is active (deleted documents may be hidden but remain accessible via other methods).

If the document does not already exist, Server 430 creates a new record in this Documents Table, with information in the creation step of this document. If doc_id is omitted or null, Server 430 may interpret that as a creation step add a DOC_ID to step, create a row in Documents Table, and return doc_id to frontend so it can tell for which document it should send subsequent steps. The creation step should have the parent and version info so the Document Table can be regenerated from the Edit Steps (these attributes don't have to be in subsequent Edit Steps). Whenever an Edit Step arrives at Server 430 which modifies/deletes a document, update Documents Table to properly reflect the latest state of the document.

One approach to link a reflow version with its corresponding PDF document is to use the parent field; a reflow doc would have the PDF-based document id in its parent field. however, just a doc id is not enough, because there could be multiple versions for that PDF document, so the system also saves the version of the PDF document. This version could be cached as well in the Documents Table (parent_version field in above definition). In addition, the Documents Table should also have a column (type field above) to specify what is the type of this document (ProseMirror, sketch or PDF), which can be inferred from the change_type field when a document is created (the system also needs to have a change_type for PDF document).

In order to allow touch-up (edits) of reflow (e.g. XML) automatically-generated from a PDF without this initially incorrect reflow from becoming part of the “official” version history of the dossier, Server 430 automatically generates the reflow (e.g. using nodejs) and persists a reflow document to the Step Table and Documents Table. This reflow content is linked to the original PDF document using the parent field but has a different document id than the original PDF.

There may be multiple versions of a given PDF document (e.g. amendments). All these different versions of a PDF doc should all have the same document id, but they will have different versions.

When user uploads a PDF document, persist PDF file on Server 430 and create an Edit Step (which is persisted in the Step Table) with the location to the PDF file embedded in the content of the document (e.g. by adding a <PDF url='. . . '/> element in the meta section). A new version of a PDF creates an Edit Step which points at a new PDF file. This is also similar to how the system persists ProseMirror documents (the differences is in the content).

When a DOC(X) file is uploaded, the system should persist the binary file on the Server 430, and then convert it to PDF (the system does not need to create a document entry for this DOC(X) file in Documents Table. Then follow the steps for the previous case when a PDF document is uploaded, embedding the following additional information in the creation Edit Step of the PDF document: the url to the originally uploaded DOC(X) file (for example adding a <origin url='. . . '/> element in the meta section).

### Application Parts

A typical patent application has four parts: abstract, descriptions, claims, drawings. The first three parts are mandatory while the drawings section is optional. It is desired to open these sections together in a continuous view, either in fixed layout viewer or reflow viewer.

Patent office rules state that each section should begin on a new page. However, it is desired to never block a user from submitting an application, even if such rules are not followed. Issues such as a section continuing on the same page as a previous section may prevent the system from mixing-and-matching document versions so this may need to be addressed before our system can handle an amendment. The system may retain each submission as a monolithic fixed-layout document (i.e. do not segment to sections or convert to reflow) and allow data capture vendor to deal with it.

For now, these four sections are combined into a single document:
For PDF, if a user uploads these sections as separate files, the system could combine them into a single PDF or retain them separately. It may be better to combine files then to split files. The next paragraph describes how to have separate TOC entities for different parts. Splitting files when user uploads a single document is also modifying a document, not that much different from combining files. Organizations must consider if/how to allow users to download or view originally-submitted files.
   If user amends a particular section, we should create a new PDF and replacing the part which is changed. System shall need to retain access to what was submitted (i.e. both 1. the new current version of the application and 2. the original uploaded amendment which replaces selective sections (or perhaps just selected pages, though we're not considering that for now)
For reflow (e.g. XML), all these sections should be combined into a single reflow document as well. Amendment will change a particular section (which is an element in the <body> element XML)

In order to show part of an application as separate documents, we need to have some special arrangement in the Documents Table: title should be the type of the section (so use title to store doccode). When frontend loads a document, it should check whether it's a PDF or reflow format, if so, whether the title is one of ABST, DESC, CLMS or DRAW, if so, scroll to the corresponding section in the PDF or XML.

### Working Paper

After a PDF is uploaded, a PDF document entry is created in Documents Table, then we create a reflow (XML) document on the Server 430 (with parent pointing at the PDF doc). User can then touch-up (edit) the reflow document before submitting the reflow document to a patent office. Before submitting, all documents are considered “working papers”.

Touch-up is allowed directly on reflow and is applied to PDF as Annotations which appear as follows:
deletions appear as strikethrough;
insertions appear as carets to indicate position and bottom-sheet to indicate inserted content (alternatively, system may display content in margin).

When a document is submitted, the marked-up PDF and the final state of the reflow content is pushed to a patent office system so they become accessible to examiners.

### Amendment

User can upload a new version of a PDF to amend a previously submitted document. An Edit Step is created atop an existing PDF document for the new PDF version; additional Edit Step(s) are created atop the existing reflow (XML) document for the new reflow version (the parent field for these Edit Steps point at the new PDF version). The system creates a new row in Documents Table to be able to show new item in ToC (analogous to reflow versions, which create a Document Table row for each version)

A new reflow document should also be created. In a patent office portal, such an amended reflow document might be considered “temporary”. User can then touch-up this temporary reflow document. When the user is satisfied with the temporary reflow document, they enter compare mode to compare this temporary reflow with the previous reflow version and confirm changes they are making (user can select to accept some changes and reject others). On submission of the amendment, generate Edit Steps from the accepted differences and push these Edit Steps to the original reflow document to create a new version in the original reflow doc, and mark the temporary reflow doc as deleted.

The first version of the reflow is aligned with the first PDF version, while the second reflow document is aligned with the second PDF version. Although the second reflow version does not have Alignment Encoding to align with first PDF version, the system uses Mapping to provide an Alignment of a range in a second reflow version to a first reflow version, which can then be aligned with first PDF document.

In the Documents Table, when user submits a new version, a new entry is added with the same doc_id, same parent_id, but a different parent_version field pointing at the step for the new PDF revision. If the Documents Table is purged, these rows can be recreated by parsing the Edit Steps.

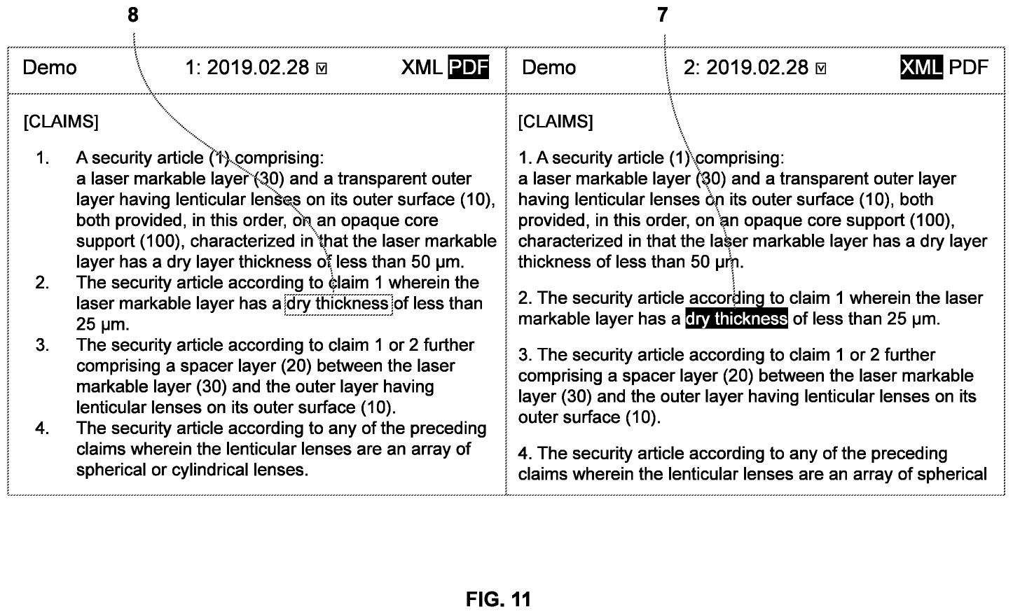

FIG. 11 illustrates a PDF view on left of version 1 and an XML view on right of version 2 (i.e. an amended application). User has made a Selection 7 in XML. An Emphasized Corresponding Range 8 appears in the PDF.

### Annotations

One of Alignment's fundamental benefits is that users or software agents can create Annotations which appear on both PDF and XML. Annotations include an Anchor (specifying a range/Selection) and various optional fields such as type (e.g. is this a highlight or a comment), content (e.g. comment), etc.

When a user creates an Anchor from a Referencing Document to a Referenced Document, a step modifying the Referencing Document is send to Server 430. Server 430 needs to understand that a new <ref> element is added; it will persist this new Anchor into an Anchors Table, which could have the following fields:

| | |
|---|---|
| 1. | id |
| 2. | doc_id: which document this Anchor is created in (i.e. |

Referencing Document)

| | |
|---|---|
| 3. | ref_doc: doc id of the Referenced Document |
| 4. | revision |
| 5. | type: 0 for ProseMirror, 1 for sketch (area), 2 for PDF text |

range, 3 for PDF page range, 4 for PDF document as a whole

| | |
|---|---|
| 6. | begin index |
| 7. | end index |

Begin/end index is for resequencing a list of Annotations, it's easier to persist these indices (which specifies the range Coordinates per http://prosemirror.net/docs/guide/#doc.indexing) than to parse all documents containing <refs> to figure out their Coordinates.

For Annotations on PDF, we don't persist the begin/end index, because unlike ProseMirror indices, we expect PDF to remain static so there's no need to resequence.

In order to perform Alignment between PDF versions or between PDF at one version and XML of another version, the system initially performs a difference between the two associated reflow version and then performs Alignment from the reflow to one or more PDF. If the Anchor Table stores the PDF start/end Coordinates, system could align these by Mapping or comparing to reflow then (if necessary) resequence through Edit Steps. The type field in this table is used to identify what format the Coordinates are in (this field can be inferred from the step).

An Annotation placed on one format is available in other formats. While there is one normalized set of Edit Steps to describe a given Annotation, the Anchor Table caches Anchors for that Annotation on all formats.

If user wants to delete or resolve a document (an Annotation is maintained as a document so resolving a comment-type Annotation is similar to marking that document for deletion), the system persists an Edit Step to Step Table to add an element to the metadata section (<state type=“deleted”/> or <state type=“resolved”/>), then the system updates the Documents Table to mark the document's state accordingly. When a document is resolved/deleted, the system does not delete Anchors in the Anchors Table with that doc_id since that deleting/resolving Edit Step can be reverted to change the document back to active state. Annotation documents which are marked as deleted are hidden by default. On the other hand, if user deletes a <ref> element in a Referencing Document, we should delete the corresponding Anchor in the Anchors Table.

Server 430 doesn't resequence Anchors every time an Edit Step arrives. Server 430 resequences (performs Mapping) Anchors only when frontend loads document at a particular version and needs to show Annotations. Server 430 need not persist these resequenced Anchors because Mapping is fast. Thereafter, front-end performs Mapping of Anchors as each local or remote step is applied. To ensure consistency, Server 430 needs transactions to be atomic when persisting an Edit Step: Server 430 locks the document row in Document Table (as a semaphore to prevent other concurrent user from modifying the same document at the same time), persists the Edit Step in Steps Table, then modifies Documents Table (always) and Anchors Table (if necessary).

Refs in documents are Anchors' golden source; these refs are persisted as Edit Steps in the documents. Server 430 parses these out of the documents and maintains the Anchors Table. However, Anchors Table and Documents Table are only caches. At any time, Anchors Table can be discarded and rebuilt from Anchors in the documents.

### Closing

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method of providing Alignment between document formats comprising, in combination:
a converter transforming a PDF to a Markup Language and an Alignment Encoding,
a PDF Viewer, and
a Markup Language Viewer; wherein
the system uses the Alignment Encoding to provide an Alignment between the PDF Viewer and the Markup Language Viewer.

2. The method of claim 1, wherein the PDF is a Tagged PDF.

3. The method of claim 1, wherein the Markup Language is an XML.

4. The method of claim 1, wherein the Alignment Encoding is stored inline with the Markup Language

5. The method of claim 4, wherein the Alignment Encoding includes recording PDF Tag MCID to one or more XML Tags.

6. The method of claim 5, wherein the Alignment Encoding is substantially restricted to XML Tags associated with elements appearing as Block Elements in an associated HTML.

7. The method of claim 6, wherein a XML Tag associates multiple character offsets with a sequence of PDF Tag MCIDs.

8. The method of claim 1, wherein the Alignment Encoding is a Standoff Alignment Encoding Store.

9. The method of claim 8, wherein the Standoff Alignment Encoding Store records correspondence between PDF Tag MCIDs and XML Tag and character offsets therein.

10. The method of claim 8, wherein the Standoff Alignment Encoding Store records correspondence between one or more PDF Tag Coordinates and one or more XML Tag Coordinates.

11. The method of claim 1, wherein the Alignment includes, upon a Selection in the Markup Language, a corresponding range in the PDF is emphasized.

12. The method of claim 1, wherein the Alignment includes, upon a Selection in the PDF, a corresponding range in the Markup Language is emphasized.

13. The method of claim 1, wherein the Alignment includes, upon a first Selection the Markup Language, a first corresponding range in the PDF is emphasized and upon a second Selection the PDF, a second corresponding range in the Markup Language is emphasized.

14. The method of claim 13, wherein the Alignment includes, upon the first Selection the Markup Language, the first corresponding range in the PDF shall scroll into view and upon the second Selection the PDF, the second corresponding range in the Markup Language shall scroll into view.

15. The method of claim 13, wherein either of a group of the first Selection and the second Selection is specified by an eye tracking focus.

16. The method of claim 1, wherein the Alignment includes an Interlining of the PDF and the Markup Language.

17. The method of claim 16, wherein the Interlining is Dynamic Interlining.

18. The method of claim 16, wherein the Interlining is Selective Interlining.

19. The method of claim 1, wherein upon one or more Edit Steps, the Markup Language, the device maintains the Alignment.

20. The method of claim 19, wherein the device updates the Alignment Encoding upon the one or more Edit Steps.

21. The method of claim 19, wherein upon a Selection, the Alignment is maintained by Mapping the Selection through the one or more Edit Steps.

22. The method of claim 1, wherein a converter transforming an Amended PDF to an Amended Markup Language such that Alignment is provided between all formats and versions.

23. A computer program comprising computer program code means adapted to perform all the steps of claims 1-22.
